(19) United States
(12) Patent Application Publication
(10) Pub. No.: US 2018/0164746 A1
(43) Pub. Date: Jun. 14, 2018

(54) METHOD FOR DETERMINING PARAMETERS FOR ADJUSTMENT OF THE WORKING OF A MECHANICAL WATCH

(71) Applicant: The Swatch Group Research and Development Ltd, Marin (CH)

(72) Inventors: Cedric Nicolas, Neuchatel (CH); Jerome Favre, Neuchatel (CH); Gregory Kissling, Macolin (CH); Dimitri Fostinis, Moutier (CH)

(73) Assignee: The Swatch Group Research and Development Ltd, Marin (CH)

(21) Appl. No.: 15/812,583

(22) Filed: Nov. 14, 2017

(30) Foreign Application Priority Data
Dec. 9, 2016 (EP) 16203098.5

(51) Int. Cl. G04D 7/00; G04B 18/02

(52) U.S. Cl. CPC G04D 7/002; G04B 18/02

(57) ABSTRACT

A method for determining parameters for adjusting a mechanical watch with an electronic device, including a measurement sensor a to measure a parameter to which the electronic device is subjected, and a device for data transmission to transmit the data provided by the measurement sensor to a device for receiving data which is external to the mechanical watch, the method including successively a step of measuring periodically, with the measurement sensor, the value of the physical parameter to which the electronic device is subjected; a step of transmitting the data provided by the measurement sensor to the external device for receiving data; a step of recording and analyzing the data transmitted to the device for receiving data with a view to deducing therefrom the conditions to which the electronic device is subjected, and a step of determining the parameters for adjusting the working of the mechanical watch as a function of the conditions of use.

### This application claims priority from European Patent Application No. 16203098.5 filed on Dec. 9, 2016; the entire disclosure of which is incorporated herein by reference.

### TECHNICAL FIELD OF THE INVENTION

The invention relates to a method for determining parameters for adjustment of the working of a mechanical watch and, more precisely, a method for determining parameters for adjustment of the working of a mechanical watch as a function of the conditions of use of this watch.

TECHNOLOGICAL BACKGROUND OF THE INVENTION

As is known, a mechanical watch comprises, in a watch case, a clockwork mechanical movement which drives a set of hands for hours and minutes. The clockwork mechanical movement comprises in particular a spiral spring, a balance wheel and an escapement, together forming a time base of the clockwork movement.

A mechanical watch, even the most precise, loses or gains a few seconds per day. Adjustment of the time base (commonly termed “working” of the watch) has the object of limiting, as much as possible, this loss or this gain.

The working of a mechanical watch depends in particular upon mechanical parameters intrinsic to the clockwork movement, such as the variation of the moment of force transmitted by the escapement to the balance wheel, or the geometry of the spiral spring. These mechanical parameters are well known to the watchmaker and are taken into account for adjustment of the working of the mechanical watch at the end of manufacture or during maintenance of the watch.

The working of a mechanical watch depends likewise upon parameters external to the watch and in particular conditions in which the watch is used. The watchmaker commonly adjusts the working of the watch on the basis of standard conditions of use. However, these standard conditions of use are difficult to estimate and, furthermore, they do not necessarily correspond to the effective conditions of use of a watch in particular.

### SUMMARY OF THE INVENTION

The present invention aims to remedy the above-mentioned disadvantages and also others as well, by proposing a method for adjusting the working of a mechanical watch which takes into account the actual conditions of use of this watch.

To this end, the invention proposes a method for determining parameters for adjustment of the working of a mechanical watch by means of an electronic device comprising:

at least one measurement sensor arranged to measure at least one physical parameter to which the electronic device is subjected, and

a device for data transmission arranged to transmit the data provided by the measurement sensor to a device for receiving data which is external to the watch.

The method according to the invention comprises the following steps, consisting of:

measuring, by means of the measurement sensor, the value of the physical parameter to which the electronic device is subjected;

transmitting the data provided by the measurement sensor to the external device for receiving data;

recording and analyzing the data collected by the external device for receiving data with a view to deducing therefrom the conditions to which the electronic device is subjected, and

determining the parameters for adjustment of the working of the mechanical watch as a function of the conditions of use.

The method according to the invention thus makes it possible to improve as much as possible the parameters for adjustment of a mechanical watch as a function of the actual conditions in which this mechanical watch is used.

According to one embodiment of the invention, the method comprises a supplementary step consisting of adjusting the working of the mechanical watch starting from the adjustment parameters determined as a function of the conditions of use.

The electronic device for collecting values of the physical parameter or parameters to which the mechanical watch is subjected can be provided for preference inside the watch case or inside the strap of the watch. In this case, after analysis of the data relating to the actual conditions in which the mechanical watch is used, adjustment of the working of the movement of the watch is effected in the course of a maintenance or repair step of the watch. Thus, the data are analyzed and the watch is adjusted by a professional who is a specialist in watches with a mechanical movement.

Another way to exploit the values of the physical parameters to which the electronic device is subjected consists of housing the electronic device in a simple strap which the user can obtain, for example, in an outlet for selling watches. The user will then wear this strap for a few days on the wrist on which he wears his watch. During this period, the value of the physical parameter (or parameters) to which the electronic device housed in the strap is subjected will be measured by means of the measurement sensor. At the end of these few days, the user returns his strap to the watch shop and the data provided by the measurement sensor will be analyzed. Analysis of these data then makes it possible to determine the manner in which the client wears the strap and to propose to him, from an assortment of mechanical watches all adjusted differently from each other, the watch, the adjustment of which corresponds best to the manner in which the client wears his watch.

According to one embodiment of the invention, the electronic device comprises a memory space for storing the data provided by the at least one measurement sensor.

In the case where the electronic device does not comprise a memory space, the data provided by the measurement sensor are transmitted directly to an external device for receiving data, for example a portable phone provided with an application for recording and analyzing the data collected by the measurement sensor with a view to deducing therefrom the conditions to which the electronic device is subjected. In the case where the electronic device comprises a memory space, the data collected by the measurement sensor are instantaneously stored in this memory space, then transmitted to an external device for receiving data with a view to analysis thereof in order to determine the conditions to which the electronic device is subjected and, consequently, the mechanical watch which the user wears.

According to one embodiment of the invention, the electronic device comprises at least one accelerometer and/or one gyrometer and/or one magnetic sensor and/or one temperature sensor and/or one pressure sensor and/or one relative humidity sensor, the data provided by the electronic device comprising at least data relating to an acceleration, including an angular acceleration, and/or data relating to a magnetic induction and/or data relating to a temperature and/or data relating to a pressure and/or data relating to the relative humidity to which the mechanical watch is subjected.

The method according to the invention hence makes it possible to improve adjustment of a mechanical watch as a function, as the case may be, of the accelerations to which the mechanical watch is subjected over time and/or variations over time of the temperature and/or of the pressure and/or of the relative humidity and/or of the magnetic field undergone by the watch. These parameters are those which are liable to cause most inaccuracy in the working of the time base of the mechanical watch.

The invention likewise proposes a mechanical watch comprising a strap connected to a watch case and an electronic device adapted for implementing a method according to the invention, this electronic device being housed inside the watch case or inside a strap of the watch, this electronic device comprising at least one measurement sensor provided to measure a physical parameter to which the mechanical watch is subjected, and a device for data transmission provided to transmit the data provided by the measurement sensor to a device for receiving data which is external to the watch.

According to one embodiment of the invention, the electronic device comprises a memory space provided to store the data provided by the measurement sensor.

According to one embodiment of the invention, the electronic device comprises at least one accelerometer and/or one gyrometer and/or one magnetic sensor and/or one temperature sensor and/or one pressure sensor and/or one relative humidity sensor.

### BRIEF DESCRIPTION OF THE FIGURES

Other features and advantages of the present invention will emerge more clearly from the detailed description which follows of examples for implementing a method according to the invention. This example is given purely by way of illustration and in a non-limiting manner and should be read in conjunction with the annexed drawings in which:

FIG. 1 is a diagram of a mechanical watch adapted for implementing a method according to the invention;

FIG. 2 is a variant of the watch of FIG. 1;

FIG. 3 details the essential components which are necessary for implementing the invention;

FIG. 4 shows schematically the steps of a method according to the invention, and

FIG. 5 shows another embodiment variant which is adapted to implement the method.

### DETAILED DESCRIPTION OF AN EMBODIMENT OF THE INVENTION

The present invention originates from the general inventive idea which consists of collecting data relating to the actual conditions of use of a mechanical watch, and of taking into account these data in order to improve adjustment of the working of the mechanical watch.

To this end, a mechanical watch according to the invention, designated in its entirety by the general reference number 1, comprises a strap 2 connected to a watch case 4 and an electronic device 6.

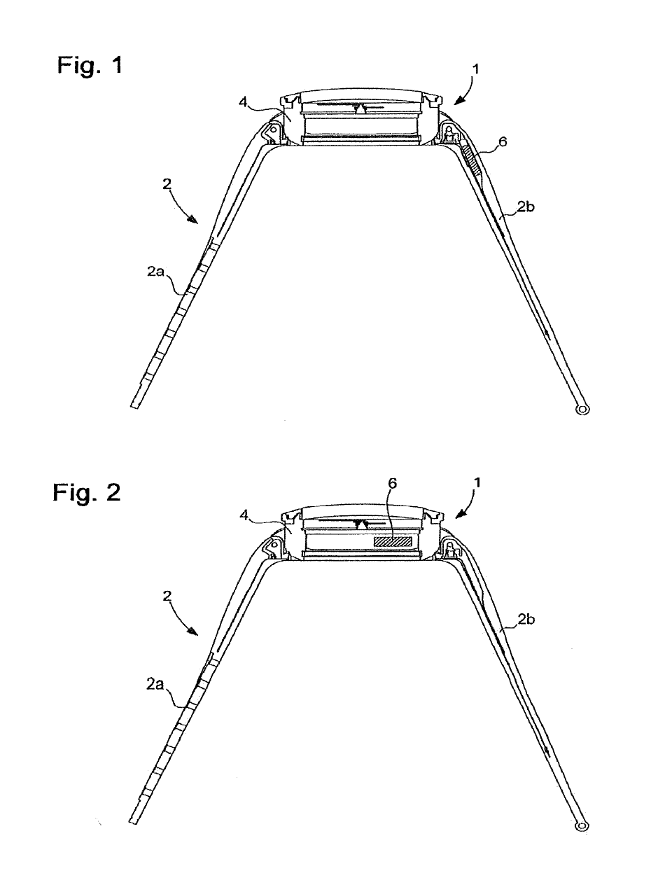

According to an embodiment of the invention illustrated in FIG. 1, the electronic device 6 is housed in one of the strands 2a or 2b of the strap 2, or else its components are distributed in the two strands 2a and 2b, the two strands 2a and 2b being, in this case, connected electrically to each other.

According to another embodiment of the invention, illustrated in FIG. 2, the electronic device 6 is housed inside the watch case 4, this watch case 4 being hermetically sealed relative to water according to known techniques.

According to yet another embodiment of the invention, not represented in the Figures, the electronic device 6 can be fixed on the structure of a clasp of the unfolding buckle type, with which the strap 2 is equipped.

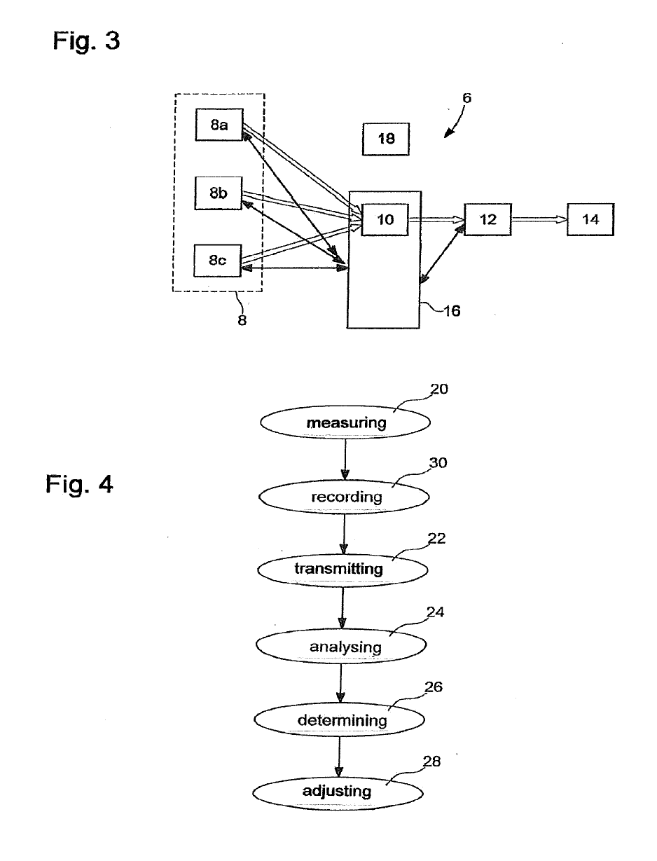

The electronic device 6 comprises in particular (see FIG. 3) at least one measurement sensor 8 which is provided to measure a physical parameter to which the mechanical watch 1 is subjected, if necessary, a memory space 10 provided to store the data provided by the at least one measurement sensor 8, and a device for data transmission 12 arranged to transmit the data provided by the measurement sensor 8 to a device for receiving data 14 which is external to the mechanical watch 1. In FIG. 3, the transfer paths of the data are represented by a thick-line arrows. The transfer of data can take place by means of a wire connection, by means of a connector and a cable, for example of the USB type or by means of a wireless connection for example of the Bluetooth type, or even of the near-field type, based on RFID technology.

In the example represented in FIG. 3, the measurement sensors 8 are three in number and comprise an accelerometer 8a, a magnetic sensor 8b and a temperature sensor 8c. The memory space 10 here is integrated in a microcontroller 16 which has the global function of controlling the plurality of measurement sensors 8, the memory space 10 and the device for data transmission 12. In FIG. 3, the control signals are represented by thin-line arrows.

In the example of FIG. 3 again, the electronic device 6 comprises, in addition, an electrical energy source 18, for example an accumulator, for supplying electrical energy to the plurality of measurement sensors 8, the microcontroller 16 and the memory space 10 thereof and also the device for data transmission 12.

It goes without saying that the present invention is not limited to the embodiments which have just been described and that various modifications and simple variants can be conceived by the person skilled in the art without departing from the scope of the invention as defined by the annexed claims.

For example, the plurality of measurement sensors 8 can comprise a single sensor, for example an accelerometer 8a, which integrates its own memory space and its own control microcontroller. In this case, a microcontroller and a memory space which are external to the sensor are very obviously not indispensable.

In another example, the energy for operation of the electrical and electronic components can be supplied by the movements of the person wearing the watch and/or by the device for receiving external data. In this case, an additional electrical energy source is not indispensable. In fact, the solution adopted for supplying the electrical and electronic components is essentially a function of the frequency of acquisition of the measurement signals provided by the sensor or sensors and the duration of the communication in the course of which the data supplied by the measurement sensor are transferred to the device for receiving data. A hybrid solution comprising an onboard energy source in addition to the energy recovered either from the movements of the wearer or from the environment (solar energy) is also conceivable. Such a solution makes it possible, for example during active wear, to provide a faster sampling frequency of the measurements (thanks to the external supply of energy), whilst in the case of low activity it is possible to reduce this sampling frequency without significant loss of information.

In the preferred embodiment of the invention, the electronic device 6 comprises a memory space 10 for storing the data supplied by the measurement sensor 8. However, it is likewise conceivable that the electronic device 6 is not provided with a memory space, in which case the data supplied by the measurement sensor 8 are transmitted directly to an external device for receiving data, such as a mobile telephone which can be equipped with an application for recording and analyzing the data supplied by the measurement sensor 8. In the case where the electronic device 6 comprises a memory space 10, the data relating to the physical parameters to which the electronic device 6 is subjected and which are measured by the measurement sensor 8 are stored temporarily in the memory space 10, then transferred to the device for receiving data 14 in order to be analyzed there with a view to deducing therefrom the conditions to which the electronic device 6 is subjected and to allowing adjustment of the mechanical watch 1 as a result.

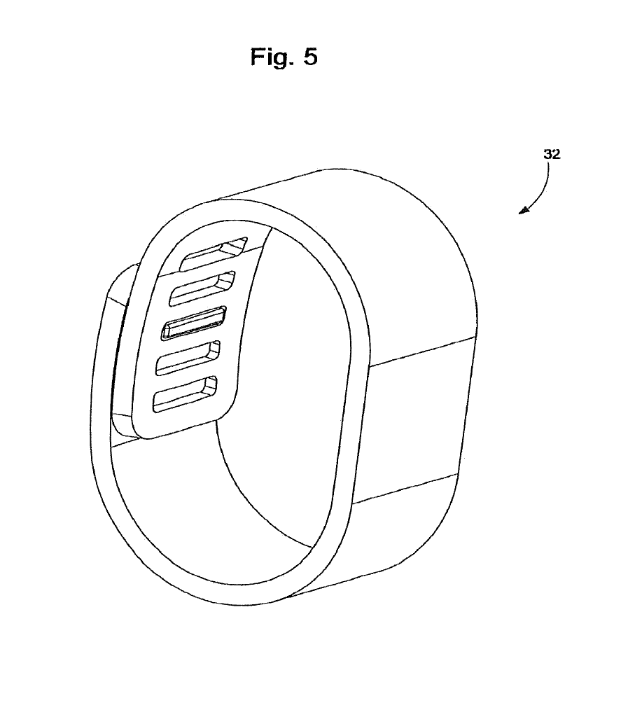

A mechanical watch according to the invention is adapted for implementing a method according to the invention, described schematically in FIG. 4 and comprising the following steps, consisting of:

measuring periodically, by means of the measurement sensor 8, the value of the physical parameter to which the electronic device 6 is subjected in step 20;

transmitting the recorded data to the device for receiving data 14 which is external to the mechanical watch 1 in step 22;

recording and analyzing the transmitted data with a view to deducing therefrom the conditions of use of the mechanical watch 1 in step 24;

determining, in step 26, the parameters for adjustment of the working of the mechanical watch 1 as a function of the conditions of use established in step 24;

adjusting the working of the movement of the mechanical watch 1 as a function of the conditions of use in step 28.

Prior to step 22 of transmission of data collected by the plurality of measurement sensors 8, these data can be stored temporarily in the memory space 10 during a step 30 with a view to subsequent transfer thereof to the device for receiving data 14.

The sensor or sensors 8 can effect measurements continuously whatever use is made of the mechanical watch 1. Alternatively, the sensor or sensors 8 effect measurements 8 only when the mechanical watch 1 is worn by a user. It is likewise possible to envisage that the accelerometer 8a effects measurements continuously and that the microcontroller 16 activates the other measurement sensors only when the accelerometer 8a detects a movement of the mechanical watch 1, i.e. when the mechanical watch is worn by a user. The measurements effected by the sensor or the sensors are effected at regular time intervals which are sufficiently short to detect variations in the measured parameters: for example time intervals of the order of a few tenths of a second to several tens of seconds for the acceleration sensor 8a, or a few minutes for the temperature sensor 8b or the induction sensor 8c.

During step 30, the data collected by the sensor or sensors are recorded in the memory space 10. This essentially concerns data collected by the sensor or sensors when the mechanical watch 1 is worn by the user, i.e. when the movements of the mechanical watch 1 are detected. But data relating to environmental conditions (magnetic field, temperature, atmospheric pressure, residual humidity) can likewise be measured during inactive phases of the watch. In addition to the measured values of the physical parameters to which the mechanical watch 1 is subjected, the collected data can likewise comprise an indication of the time periods during which the mechanical watch 1 is worn and periods of time during which the mechanical watch 1 is immobile.

During step 22, the stored data are transmitted to the device for receiving data 14 which is external to the mechanical watch 1. The transmission can be effected via any type of link, preferably wireless, such as for example a Bluetooth link.

During step 24, the transmitted data are analyzed in order to determine the conditions of use of the watch, and in particular:

the data relating to the accelerations, including the angular accelerations, undergone by the mechanical watch 1 are analyzed in order to determine in what position the watch is situated most frequently: vertical, horizontal, inclined position, and in order then to estimate the development of the friction at the level of a balance wheel of the watch, which friction is likely to influence the working of the mechanical watch 1;

the data relating to the induction undergone by the mechanical watch 1 are analyzed in order to determine the development over time of the magnetic field to which the watch is subjected and to estimate the impact of this magnetic field on the working of the mechanical watch 1;

the data relating to the temperature to which the mechanical watch 1 is exposed are analyzed in order to determine the development over time of the temperature undergone by the mechanical watch 1, and to estimate the consequences of this temperature, in particular on the spiral spring and the balance wheel of the mechanical watch 1 (expansion or contraction), and therefore on the working of the mechanical watch 1;

the data relating to the pressure and to the humidity give indications about physical values which influence ageing of the lubricants, and therefore friction of the movable parts and the working of the watch;

the data relating to angular accelerations which give valuable information about the rotations undergone by the movable elements of the movement and which complete the information provided by the accelerometer about impacts and other mechanical disturbances to the working of the watch, such as abrupt movements of the wearer.

During step 26, the adjustments which must be effected in order to improve the working of the movement of the mechanical watch 1 are determined, as a function of the conditions of use of the mechanical watch 1 which were determined in step 24.

Finally, during step 28, the working of the mechanical watch 1 is adjusted as a function of the adjustments to be effected in order to improve the working thereof, which were determined during step 26.

Preferably, the steps of transmission 22, of analysis 24, of determination of the adjustment parameters 26 and of adjustment 28 are produced in the course of a maintenance or repair step of the mechanical watch 1. Hence, the data are analyzed and the mechanical watch 1 is adjusted by a professional who is a specialist in watches with mechanical movements. It is also possible that the professional decides to effect servicing of the watch and to renew the lubricants for the critical movable parts for example.

The invention likewise relates to a strap 32 as illustrated in FIG. 5. This strap 32 comprises an electronic device 6 of the type described above which is adapted for implementing the method according to one of the preceding variants and which comprises at least one measurement sensor 8 provided in order to measure a physical parameter to which the strap 32 is subjected, and a device for data transmission 12 which is provided in order to transmit data provided by the at least one measurement sensor 8 to a device for receiving data 14 which is external to the strap 32. An electrical energy source 18 must likewise be provided.

It can likewise be conceived that the electronic device 6 with its various components is designed in the form of a module which will be fixed externally for example on the strap of the watch or on the case of the watch for the duration of the test. It is likewise conceivable that such a module is housed provisionally inside the case of the watch.

The present description specifies that step 20 of measuring the value of the physical parameter to which the electronic device 6 is subjected is effected periodically by means of the measurement sensor 8. There is meant by “periodically”, that the measurement must be effected over the length of the period during which the value of the physical parameter (or parameters), to which the electronic device 6 is subjected, are recorded. On the other hand, these measurement readings can be made at regular time intervals or not.

Parts list
1. Mechanical watch
2. Strap
2a, 2b. Strands of the strap
4. Watch case
6. Electronic device
8. Measurement sensor
8a. Accelerometer
8b. Magnetic sensor
8c. Temperature sensor
10. Memory space
12. Device for data transmission
14. Device for receiving data
16. Microcontroller
18. Source of electrical energy
20. Step of measuring the value of the physical parameter
22. Step of transmitting data
24. Step of analysis of transmitted data
26. Step of determining parameters for adjustment of the working of the mechanical watch
28. Step for adjustment of the working of the mechanical watch
30. Step of recording data collected by the measurement sensor
32. Strap

1. A method for determining parameters for adjustment of the working of a mechanical watch with an electronic device comprising:
at least one measurement sensor arranged to measure at least one physical parameter to which the electronic device is subjected, and
a device for data transmission arranged to transmit the data provided by the measurement sensor to a device for receiving data which is external to the mechanical watch, the method comprising successively:
a step of measuring periodically, with the measurement sensor, the value of the physical parameter to which the electronic device is subjected;
a step of transmitting the data provided by the measurement sensor to the device for receiving data;
a step of recording and analyzing the data transmitted to the device for receiving data with a view to deducing therefrom the conditions to which the electronic device is subjected, and
a step of determining the parameters for adjustment of the working of the mechanical watch as a function of the conditions of use.

2. The method according to claim 1, further comprising a supplementary step of adjusting the working of the mechanical watch starting from the adjustment parameters determined as a function of the conditions of use.

3. The method according to claim 1, wherein the electronic device comprises a memory space for storing the data provided by the at least one measurement sensor in the course of step.

4. The method according to claim 2, wherein the electronic device comprises a memory space for storing the data provided by the at least one measurement sensor in the course of step.

5. The method according to claim 1, wherein the at least one measurement sensor comprises at least one accelerometer and/or one gyrometer and/or one magnetic sensor and/or one temperature sensor and/or one pressure sensor and/or one relative humidity sensor, wherein the data provided by the at least one measurement sensor comprises at least data relating to an acceleration, and/or data relating to a magnetic induction and/or data relating to a temperature to which the watch is subjected.

6. The method according to claim 2, wherein the at least one measurement sensor comprises at least one accelerometer and/or one gyrometer and/or one magnetic sensor and/or one temperature sensor and/or one pressure sensor and/or one relative humidity sensor, wherein the data provided by the at least one measurement sensor comprises at least data relating to an acceleration, and/or data relating to a magnetic induction and/or data relating to a temperature to which the watch is subjected.

7. The method according to claim 3, wherein the at least one measurement sensor comprises at least one accelerometer and/or one gyrometer and/or one magnetic sensor and/or one temperature sensor and/or one pressure sensor and/or one relative humidity sensor, wherein the data provided by the at least one measurement sensor comprises at least data relating to an acceleration, and/or data relating to a magnetic induction and/or data relating to a temperature to which the watch is subjected.

8. The method according to claim 4, wherein the at least one measurement sensor comprises at least one accelerometer and/or one gyrometer and/or one magnetic sensor and/or one temperature sensor and/or one pressure sensor and/or one relative humidity sensor, wherein the data provided by the at least one measurement sensor comprises at least data relating to an acceleration, and/or data relating to a magnetic induction and/or data relating to a temperature to which the watch is subjected.

9. The method according to claim 1, wherein the recording of the data is effected during the periods when the mechanical watch is being worn.

10. The method according to claim 1, wherein the step of transmitting the data, the step of analyzing the data, the step of determining the parameters for adjustment of the working of the mechanical watch as a function of the conditions of use and the step of adjusting the working of the mechanical watch are effected in the course of a maintenance or repair step of the mechanical watch.

11. A mechanical watch comprising a strap connected to a watch case and an electronic device adapted for implementing the method according to claim 1, the electronic device being housed inside the watch case or inside the strap of the mechanical watch or in a clasp of the unfolding buckle type equipping the strap, the electronic device comprising at least one measurement sensor provided to measure a physical parameter to which the mechanical watch is subjected, and a device for data transmission provided to transmit the data provided by the at least one measurement sensor to a device for receiving data which is external to the mechanical watch.

12. The mechanical watch according to claim 11, wherein the electronic device comprises a memory space provided to store the data provided by the at least one measurement sensor.

13. The mechanical watch according to claim 11, wherein the at least one measurement sensor comprises at least one accelerometer and/or one gyrometer and/or one magnetic sensor and/or one temperature sensor and/or one temperature sensor and/or one relative humidity sensor.

14. The mechanical watch according to claim 12, wherein the at least one measurement sensor comprises at least one accelerometer and/or one gyrometer and/or one magnetic sensor and/or one temperature sensor and/or one temperature sensor and/or one relative humidity sensor.

15. A strap comprising an electronic device adapted for implementing the method according to claim 1, wherein the electronic device comprises at least one measurement sensor provided to measure a physical parameter to which the strap is subjected, and a device for data transmission arranged to transmit the data provided by the at least one measurement sensor to a device for receiving data which is external to the strap.
